(19) United States
(12) Patent Application Publication
(10) Pub. No.: US 2008/0053584 A1
(43) Pub. Date: Mar. 6, 2008

(54) PNEUMATIC TIRE

(75) Inventor: Masaaki Ohara, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 11/839,940

(22) Filed: Aug. 16, 2007

(30) Foreign Application Priority Data
Aug. 31, 2006 (JP) 2006-235960

(51) Int. Cl. B60C 11/03

(52) U.S. Cl. 152/209.25

(57) ABSTRACT

A pneumatic tire provided with a tread pattern on which a plurality of blocks are formed with three circumferential grooves which extend along a circumferential direction of the tire and lateral grooves which traverse the circumferential grooves, wherein the lateral groove disposed between the circumferential grooves has a depth that is from 40 to 70% of a depth of the circumferential groove, a groove bottom sipe with both open ends is formed on a groove bottom of the lateral groove, and a land portion sipe, whose length in the circumferential direction of the tire is longer than that in a width direction of the tire, is formed on the block.

### BACKGROUND OF THE INVENTION

1. Field of the Invention

The present invention relates to a pneumatic tire provided with a tread pattern on which a plurality of blocks are formed with circumferential grooves, which extend in a circumferential direction of the tire, and lateral grooves.

2. Description of the Related Art

As a pneumatic tire which secures driving performance on a snowy road without forming a sipe in a block, a pneumatic tire provided with a tread pattern shown by FIG. 6 or FIG. 7 is known. Such a pneumatic tire commonly has 4 to 6 circumferential grooves 1 that extend along a circumferential direction of a tire, and has relatively small blocks 10 partitioned by the circumferential grooves 1 and lateral grooves 2.

However, such a pneumatic tire has relatively small blocks, and therefore the blocks are apt to be deformed. This caused a problem of easy occurrence of toe and heel wear. Also, against a backdrop of the market, a demand on driving performance on a snowy road has been changing and economical efficiency (improvement of wear and irregular wear resistance) has become much important as a result of repletion of studless tires (improvement of driving performance on a snowy and icy road) and improvement in road surface conditions, and accordingly, a configuration that meets the above demand is being sought. That is, a demand on driving performance on a snowy road for a winter tire has been being specialized in driving performance on a road covered with shallow snow, and a demand for a tread pattern has been radically changing from a conventional tread pattern required shear force in the snow into a tread pattern required a scratching effect by an edge line of a block.

On the other hand, in the following Japanese Unexamined Patent Publication (Kokai) No. 10-86613, a pneumatic tire is proposed, which is provided with a lateral thin groove having a narrow width and a shallow bottom between blocks and a sipe on the groove bottom of the lateral thin groove, and the sipe extends along the lateral thin groove and has a discontinuity, with the intent of suppressing irregular wear and improving performance on snow and ice. And also, as another type of a sipe, a sipe which bends along a lateral thin groove is disclosed.

However, there was a problem in the tire disclosed in Japanese Unexamined Patent Publication (Kokai) No. 10-86613, such that suppression effect on irregular wear was less since the sipe provided on the lateral thin groove has a discontinuity and preferably is terminated halfway through the lateral thin groove. And also, it is hard to say in some ways that the driving performance on a road covered with shallow snow is good enough, since the lateral thin groove has the narrow width and the shallow bottom. In addition, since it is a tire without a sipe inside a block or with a sipe that extends along a width direction of the tire, movement of the block in the width direction of the tire is small and, with this regard, the tire has a disadvantage in reduction of stepped wear in a circumferential direction of the tire.

### SUMMARY OF THE INVENTION

The object of the present invention is to provide a pneumatic tire which is particularly good in terms of driving performance on a road covered with shallow snow and is not apt to bring irregular wear such as toe and heel wear.

The above described object can be achieved by the present invention as follows.

That is, the present invention provides a pneumatic tire provided with a tread pattern on which a plurality of blocks are formed with three circumferential grooves which extend along a circumferential direction of the tire and lateral grooves which traverse the circumferential grooves, wherein the lateral groove disposed between the circumferential grooves has a depth that is from 40 to 70% of a depth of the circumferential groove, a groove bottom sipe with both open ends is formed on a groove bottom of the lateral groove, and a land portion sipe, whose length in the circumferential direction of the tire is longer than that in a width direction of the tire, is formed on the block.

According to the pneumatic tire of the present invention, driving performance on a road covered with shallow snow becomes good since the lateral groove disposed between circumferential grooves has a sufficient depth. And also, since the depth of the lateral groove between the circumferential grooves is shallower than that of the circumferential grooves, deformation caused by anteroposterior force of the block can be prevented properly, and in addition, the groove bottom sipe in the lateral groove reduces stepped wear, since stress acting on an edge line of the block is alleviated when the anteroposterior force is acted on the block. Furthermore, since the length of the circumferential direction of the tire in the land portion sipe provided on the block is long, the block can move easily in the width direction of the tire, and by developing wear progress in an orthogonal direction to stepped wear in the longitudinal direction, stepped wear in the circumferential direction can be reduced. As a result, the pneumatic tire is provided, wherein driving performance particularly on a road covered with shallow snow is good and irregular wear such as toe and heel wear does not occur easily.

In the pneumatic tire mentioned hereinbefore, it is preferable that the lateral groove disposed between the circumferential grooves has a bend section in a circular arc shape. By providing the bend section in the lateral groove, edge lines of the block can be constituted with multiple sides, and by shortening a length of an edge line, there obtains an effect that stepped wear hardly visually stand out. Also, by forming the bend section in a circular arc shape, a low rigid region on an apex of the bend section is eliminated, and in combination thereof, stepped wear can be reduced as compared with a square shape.

And also it is preferable that the land portion sipe has two bend sections and a sipe section between the bend sections, the sipe section extends in a direction at an angle of from 70 to 110° to the circumferential direction of the tire, and both ends of the land portion sipe are closed inside the block. By providing such the sipe section between the bend sections, an edge effect of the sipe section is brought so that braking and driving performance can be improved. Also, by segmentalizing an edge line of the sipe, there obtains an effect that stepped wear hardly visually stand out. Furthermore, since both ends of the land portion sipe are closed inside the block, deformation of the block on both sides of the land portion sipe can properly be prevented, and thus irregular wear bounded by the land portion sipe can be prevented.

And also it is preferable that the circumferential groove is formed in a zigzag. Because of this, a scratch by an edge line of the block that faces the circumferential groove becomes greater, and thus driving performance on a snowy road can be further improved.

### BRIEF DESCRIPTION OF THE DRAWINGS

FIG. 1 is an elevation view showing an example of a tread pattern of a pneumatic tire of the present invention;

FIG. 2 is an enlarged view of a relevant part showing a fracture cross section fractured along a groove bottom sipe of a lateral groove bottom of an example of a pneumatic tire of the present invention;

FIG. 3 is an enlarged view of a relevant part showing a block of an example of a pneumatic tire of the present invention;

FIG. 4 is an enlarged view of a relevant part showing a fracture cross section fractured along a groove bottom sipe of a lateral groove bottom of other examples of a pneumatic tire of the present invention;

FIG. 5 is an enlarged view of a relevant part showing a block of other examples of a pneumatic tire of the present invention;

FIG. 6 is an elevation view showing an example of a tread pattern of a conventional tire (Comparative Example 1); and

FIG. 7 is an elevation view showing an example of a tread pattern of a conventional tire (Comparative Example 2).

### DETAILED DESCRIPTION OF THE PREFERRED EMBODIMENTS

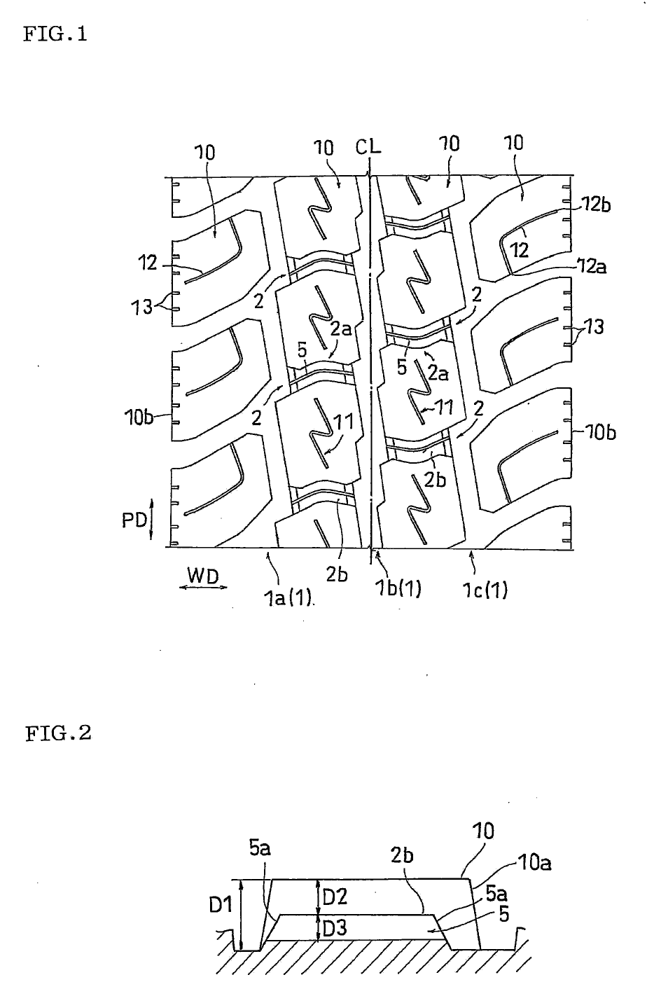

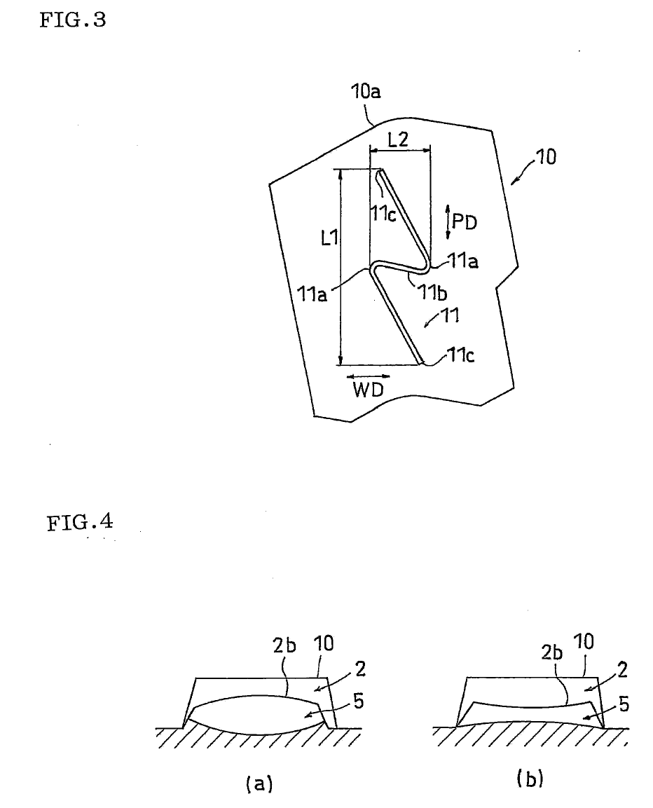

Hereinafter, the embodiment of the present invention will be explained with referring to the drawings. FIG. 1 is an elevation view showing an example of a tread pattern of a pneumatic tire of the present invention. FIG. 2 is an enlarged view of a relevant part showing a fracture cross section fractured along a groove bottom sipe of the lateral groove bottom. FIG. 3 is an enlarged view of a relevant part showing the block.

The pneumatic tire of the present invention is provided with, as shown in FIG. 1, the tread pattern on which a plurality of blocks 10 are formed with three circumferential grooves 1, which extend along the circumferential direction PD of the tire, and the lateral grooves 2 which traverse the circumferential grooves 1. In the present embodiment, an example where the circumferential groove 1 is formed in a zigzag and the lateral groove 2 has the bend section 2a in a circular arc shape is explained.

Some or all of three circumferential grooves 1 can be sublinear grooves, but preferably some circumferential grooves 1 have a zigzag pattern in view of improvement in driving performance on a snowy road, and more preferably all circumferential grooves 1 have a zigzag pattern.

The circumferential groove 1 in a zigzag pattern can be provided by forming a zigzag wall surface on the block 10 as shown by the circumferential groove 1b in the middle, by inclining a wall surface of the block 10 from a circumferential direction PD of the tire as shown by the circumferential grooves 1a and 1c on both sides, or by other methods.

Although three circumferential grooves 1 may be disposed on any position of the tire widthwise WD, it is preferable that the circumferential groove 1b in the middle is disposed in a vicinity of an equator line CL of the tire. And it is preferable that the circumferential grooves 1a and 1c on both sides are disposed such that the centers thereof are disposed within a region from 30 to 70% of a distance from an equator line CL of the tire to an edge line 10b of the block 10 on the tread edge region.

The lateral groove 2 can be any as long as it traverses the circumferential groove 1, and it can be formed in a width direction WD of the tire or at an inclined angle from the width direction WD of the tire. In an example shown in the figure, the lateral groove 2 has a single bend section 2a in a circular arc shape, and a lateral groove 2 in a downturned shape and a lateral groove 2 in a reverse downturned shape are disposed on left and right.

The curvature radius of the bend section 2a of the lateral groove 2 is preferably from 3 to 10 mm based on the edge line of the block 10 on a median side in view of reduction of stepped wear, although it may vary depending on an angle of the bend section of the lateral groove 2.

The lateral groove 2 disposed between the circumferential grooves 1 has, as shown in FIG. 2, the depth D2 that is from 40 to 70% of the depth D1 of the circumferential groove 1, and preferably has the depth D2 that is from 50 to 60% of the depth D1 of the circumferential groove 1. By adjusting the depth D2 of the lateral groove 2 to the range, both driving performance on a road covered with shallow snow and a suppression effect on irregular wear can be ensured. Incidentally, the depth D1 of the circumferential groove 1 is commonly from 8 to 16 mm.

It is not necessary that the depth D2 of the lateral groove 2 is uniform throughout the entire lateral groove 2, and when the depth D2 varies, a mean value of the depth D2 should satisfy the above range. Incidentally, a groove width of the lateral groove 2 can be as the same width as that of the circumferential groove 1. However, the groove width of the lateral groove 2 is preferably from 5 to 10 mm, since it is preferred that the groove width thereof is adjusted to be a little narrower than that of the circumferential groove 1 in order to retain an effect on reduction of stepped wear and to secure a longitudinal length of the block.

A groove bottom sipe 5 with both open ends 5a is formed on the groove bottom 2b of the lateral groove 2. Here, that both ends 5a are open denotes a state where the groove bottom sipe 5 is not closed inside the groove bottom 2b of the lateral groove 2 and the apertures 5a are laid on a wall surface on both sides.

It is preferable that the groove bottom sipe 5 is formed near the center of the groove bottom 2b of the lateral groove 2. Accordingly, it is preferable that when the lateral groove 2 has the bend section 2a, the groove bottom sipe 5 also has a bend section.

A depth D3 of the groove bottom sipe 5 is preferably from 15 to 30% of the depth D1 of the circumferential groove 1, in view of relaxation of stress that acts on an edge line of the block and reduction of stepped wear, and is more preferably from 15 to 25%. The depth D3 of the groove bottom sipe 5 is preferably from 1.5 to 2.5 mm in a specific term. Incidentally, it is not necessary that the depth D3 of the groove bottom sipe 5 is uniform entirely, and when the depth D3 varies, a mean value of the depth D3 should preferably satisfy the above described range.

A groove width of the groove bottom sipe 5 is preferably from 0.3 to 1.0 mm, and more preferably from 0.5 to 0.7 mm, in view of maintaining stiffness against anteroposterior force of the block 10 and preventing crack from occurring from the bottom of the sipe.

As shown in FIG. 3, the block 10 has the land portion sipe 11 whose length L1 in the circumferential direction PD of the tire is longer than the length L2 in the width direction WD of the tire. In the present embodiment, an example where the land portion sipe 11 has two bend sections 11a and also a sipe section 11b between the bend sections 11a, the sipe section 11b extends in a direction at an angle from 70 to 110° to the circumferential direction PD of the tire, and both ends 11c of the land portion sipe 11 are closed inside the block 10.

The land portion sipe 11 can be any in its shape and size as long as the length L1 in the circumferential direction PD of the tire is longer than the length L2 in the width direction WD of the tire, but it is preferable to have a plurality of bend sections 11a. With the bend sections, the edge line of the sipe is segmentalized and thereby an effect for visually preventing stepped wear from standing out is obtained.

A curvature radius of the bend section 11a of the land portion sipe 11 is preferably from 2 to 5 mm based on the center of the groove width of the land portion sipe 11, in view of reduction of stepped wear.

And also, it is preferable to have the sipe section 11b between the bend sections 11a and the sipe section lib extends in a direction at an angle from 70 to 110° to the circumferential direction PD of the tire, in view of improvement in braking performance and driving performance due to the edge effect.

Although both ends 11c of the land portion sipe 11 may be open to a wall surface 10a of the block 10, it is preferred that they are closed inside the block 10 in view of preventing irregular wear bounded by the land portion sipe.

Incidentally, a groove width of the land portion sipe 11 is preferably from 0.5 to 0.7 mm, and a groove depth of the land portion sipe 11 is preferably from 50 to 70% of that of the circumferential groove 1.

On the tread edge regions on both sides of the circumferential grooves 1a and 1c on both sides, the blocks 10 are formed, which are formed by the lateral grooves 2 extending outside the circumferential grooves 1a and 1c. On the block 10, a sipe 12 in a sub-L shape is formed, and one end 12a of the sipe 12 is open to the lateral groove 2 and the other end 12b is closed inside the block. On the edge 10b of the block 10, a plurality of incisions 13 are formed.

The pneumatic tire of the present invention is equivalent to common pneumatic tires except for being provided with the above tread pattern, and therefore any conventionally known arts such as materials, shapes, structures and production methods can be employed for the present invention.

The pneumatic tire of the present invention is good in terms of driving performance particularly on a road covered with shallow snow, and is provided with a tread pattern which is hard to produce irregular wear such as toe and heel wear, so as to be useful particularly as a winter tire, and among others as a tire for driving on a road covered with shallow snow. Incidentally, a road covered with shallow snow denotes a road surface that is covered with an amount of snow that falls in the Pacific Ocean side region on the lowland of the western Japan.

### Other Embodiments

Hereinafter, other embodiments of the present invention will be explained.

(1) Although an example provided with the tread pattern on which the block shown in FIG. 1 is formed is explained in the above described embodiment, a shape of the block is not limited thereto and other shapes such as sub-square, rectangular, parallelogram, diamond shape and the like can be employed.

(2) Although an example where the groove bottom sipe having a constant depth is formed on the groove bottom of the lateral groove having a constant depth was explained in the above described embodiment, a lateral groove and a groove bottom sipe of the present invention may not have a constant depth as shown in FIG. 4(a) to 4(b).

In an example shown by FIG. 4(a), a depth of the lateral groove 2 is the shallowest near the center of the lateral groove 2, and a depth of the groove bottom sipe 5 is the deepest near the center of the lateral groove 2. Also, in an example shown by FIG. 4(b), a depth of the lateral groove 2 is the deepest near the center of the lateral groove 2, and a depth of the groove bottom sipe 5 is the shallowest near the center of the lateral groove 2.

(3) Although an example where a land portion sipe in a reverse Z shape is formed on the block is explained in the above described embodiment, a sipe in various shapes can be formed in the present invention as shown in FIG. 5(a) to 5(c).

In an example shown by FIG. 5(a), a land portion sipe 11 in a dogleg shape is formed on the block 10. It is preferable that the bend section is also in a circular arc shape in this case.

In an example shown by FIG. 5(b), a land portion sipe 11 in a waveform is formed on the block 10. In the example shown by way of the figure, there exist 3 bend sections, but it is preferable to have from 2 to 4 bend sections. It is because a sipe section between bend sections comes close to a direction of 70 to 110° to the circumferential direction PD of the tire as the number of bend sections increases, so as to improve braking and driving performance by the edge effect.

In an example shown by FIG. 5(c), a land portion sipe 11 in a rectangular waveform is formed on the block 10. The land portion sipe 11 in a rectangular waveform is preferable since it has a sipe section in a direction of 70 to 110° to the circumferential direction PD of the tire, so as to improve braking and driving performance by the edge effect.

(4) In the above described embodiment, an example of the lateral groove having a single bend section was explained, but the lateral groove may have two or more bend sections. Also, alignment of lateral grooves is not limited to that in which lateral grooves in a downturned shape on the same side are disposed, in order, along the circumferential direction PD of the tire, but may be that in which a lateral groove in a downturned shape and a lateral groove in a reverse downturned shape are disposed alternately.

### EXAMPLES

Hereinafter, the structure and effect of the present invention will be explained specifically by way of Examples and the like. Incidentally, evaluation of respective performance of a tire was conducted as follows.

(1) Driving Performance on Road with Shallow Snow

A tire was loaded on a test truck (small 2 ton truck), which was then driven on a road covered with shallow snow (snow depth of approx. 5 mm) under a load condition of one man riding to test straight drive, turn drive, braking and the like so as to evaluate the test truck by way of a sensory test of a driver. Incidentally, the evaluation is rated by an exponential figure when a conventional tire (Comparative Example 1) is rated as 100, and greater figures denote better results.

(2) Stepped Wear in Longitudinal Direction

A tire was loaded on a test truck (small 2 ton truck), and stepped wear loss (maximum elevation difference at an edge of a block before and after incurring wear) was measured under a load condition of one man riding when the test truck was driven for a distance of 8000 km on a dry paved roadway, and the evaluation was conducted by an exponential figure. Incidentally, the evaluation is rated by an exponential figure when a conventional tire (Comparative Example 1) is rated as 100, and greater figures denote better results.

(3) Irregular Wear of Land Portion Sipe

A tire was loaded on a test truck (small 2 ton truck), and irregular wear loss of a land portion sipe (maximum elevation difference at an edge of a land portion sipe before and after incurring wear) was measured when the test truck was driven for a distance of 8000 km on a dry paved roadway, and the evaluation was conducted by an exponential figure. Incidentally, the evaluation is rated by an exponential figure when Comparative Example 3 is rated as 100, and greater figures denote better results.

### Comparative Example 1

### Conventional Tire

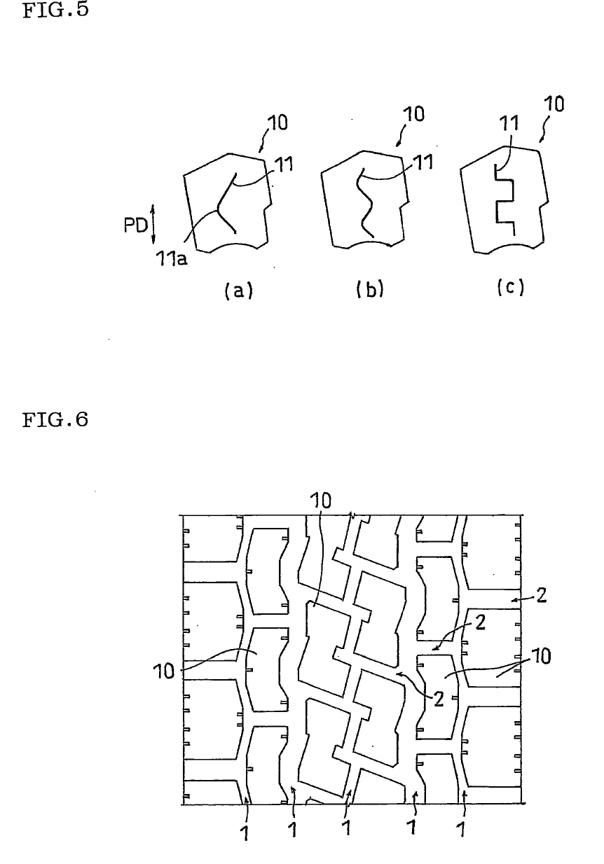

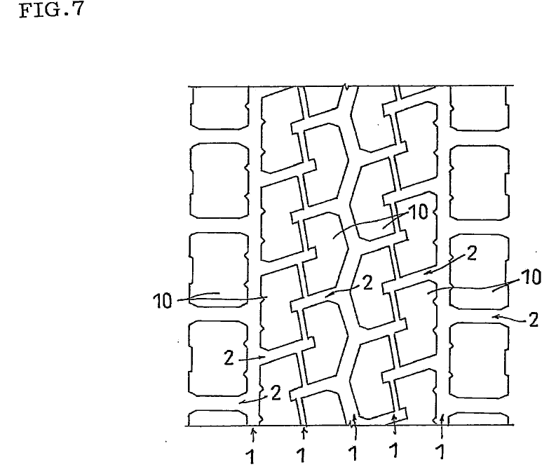

In the tread pattern shown by FIG. 6, the depth of the circumferential groove and the lateral groove were adjusted to 12 mm, and a radial tire having a size of 195/85R16 was produced. Using the tire, evaluation on the above respective performance was conducted. The results are shown in Table 1.

### Comparative Example 2

### Conventional Tire

In the tread pattern shown by FIG. 7, the depth of the circumferential groove and the lateral groove were adjusted to 12 mm, and a radial tire having a size of 195/85R16 was produced. Using the tire, evaluation on the above respective performance was conducted. The results are shown in Table 1.

### Example 1

A radial tire having a size of 195/85R16 was produced by adjusting the depth of the circumferential groove to 12 mm, the groove width to 8.5 mm, the depth of the lateral groove to 6 mm, the groove width to 6 mm, the curvature radius of the bend section to 10 mm, the size of the block to approximately 34 mm×34 mm, the depth of the groove bottom sipe to 1.5 mm, the groove width to 0.6 mm, the depth of the land portion sipe to 6.5 mm, the groove width to 0.6 mm, L1=20 mm and L2=7.5 mm in the tread pattern shown in FIG. 1. The evaluation results on respective performance of the tire will be shown in Table 1.

### Example 2

A radial tire was produced in the same manner as in Example 1 except for adjusting the depth of the lateral groove to 8 mm and the depth of the groove bottom sipe to 2 mm. The evaluation results on respective performance of the tire will be shown in Table 1.

### Example 3

A radial tire was produced in the same manner as in Example 1 except for forming, as a land portion sipe, the sipe in a waveform, which has 3 bend sections, L1=20 mm and L2=5 mm as shown by FIG. 5(b). The evaluation results on respective performance of the tire will be shown in Table 1.

### Comparative Example 3

A radial tire was produced in the same manner as in Example 1 except for forming a groove bottom sipe with both closed ends (terminated at a position 5 mm off from the edge of the groove bottom of the lateral groove, respectively) instead of a groove bottom sipe with both open ends. Using the tire, evaluation on the above respective performance was conducted. The results are shown in Table 1.

### Referential Example 1

A radial tire was produced in the same manner as in Example 1 except for forming a land portion sipe with both ends that were extended in linear form and open to an edge of a block instead of a land portion sipe that was closed inside a block. Using the tire, evaluation on the above respective performance was conducted. The results are shown in Table 1.

TABLE 1

| | Comparative | Comparative | | | | Comparative | Referential |
|---|---|---|---|---|---|---|---|
| | Example 1 | Example 2 | Example 1 | Example 2 | Example 3 | Example 3 | Example 1 |
| Driving | 100 | 94 | 108 | 110 | 104 | 93 | 112 |
| performance on | | | | | | | |
| road with | | | | | | | |
| shallow snow | | | | | | | |
| Stepped wear in | 100 | 102 | 113 | 108 | 115 | 95 | 104 |
| longitudinal | | | | | | | |
| direction | | | | | | | |
| Irregular wear | — | — | 100 | 98 | 105 | 102 | 94 |
| of land portion | | | | | | | |
| sipe | | | | | | | |

As shown by the results in Table 1, both driving performance on a road covered with shallow snow and wear resistance performance in the Examples were superior to those in Conventional tires. In Comparative Example 3, on the other hand, stepped wear loss increased more since the groove bottom sipe with both closed ends was formed. Incidentally, it is learned from the results of Referential Example 1 that irregular wear of a land portion sipe decreases when a land portion that is closed inside a block is formed.

What is claimed is:

1. A pneumatic tire provided with a tread pattern on which a plurality of blocks are formed with three circumferential grooves which extend along a circumferential direction of the tire and lateral grooves which traverse the circumferential grooves,
wherein the lateral groove disposed between the circumferential grooves has a depth that is from 40 to 70% of a depth of the circumferential groove, a groove bottom sipe with both open ends is formed on a groove bottom of the lateral groove, and a land portion sipe, whose length in the circumferential direction of the tire is longer than that in a width direction of the tire, is formed on the block.

2. The pneumatic tire according to claim 1, wherein the lateral groove disposed between the circumferential grooves has a bend section in a circular arc shape.

3. The pneumatic tire according to claim 1, wherein the land portion sipe has two bend sections and a sipe section between the bend sections, the sipe section extends in a direction at an angle of from 70 to 110° to the circumferential direction of the tire, and both ends of the land portion sipe are closed inside the block.

4. The pneumatic tire according to claim 1, wherein the circumferential groove is formed in a zigzag.
